(19) United States
(12) Patent Application Publication
(10) Pub. No.: US 2003/0033378 A1
(43) Pub. Date: Feb. 13, 2003

(54) Method and apparatus for automatically creating and dynamically managing websites

(76) Inventors: Fred Needham, Houston, TX (US); Stephen Gartrell, Houston, TX (US)

Correspondence Address: ROSENTHAL & OSHA L.L.P., Suite 2800, 1221 McKinney St., Houston, TX, 77010, US

(21) Appl. No.: 10/155,890

(22) Filed: May 20, 2002

Related U.S. Application Data
(60) Provisional application No. 60/291,828, filed on May 18, 2001.

(51) Int. Cl. G06F 15/16

(52) U.S. Cl. 709/218; 715/501.1

(57) ABSTRACT

A system for creating and dynamically managing websites includes a set of tables; a database associated with the set of tables; and a software tool for generating a web interface based on the database using the set of tables. A method for creating and dynamically managing websites includes creating a set of tables associated with a database; and generating a web interface based on the database using the set of tables.

### CROSS-REFERENCE TO RELATED APPLICATIONS

This application claims priority under Section 119 of U.S. Provisional Application No. 60/291,828, filed on May 18, 2001.

### BACKGROUND OF INVENTION

A modern computer system comprises a microprocessor, memory, and peripheral computer resources, i.e., monitor, keyboard, software programs, etc. The microprocessor includes arithmetic, logic, and control circuitry that interpret and execute instructions from a computer program. FIG. 1 shows a prior art block diagram of a microprocessor (22) having, among other components, a central processing unit (“CPU”) (24), a memory controller (26), also known as a load/store unit, and on-board, or level 1, cache memory (30). The microprocessor (22) is also connected to external, or level 2, cache memory (32) and to the main memory (34) of the computer system. The basic functionality of a computer is dictated by the type of operating system it uses. Various operating systems exist in the market place, including the “Windows” Operating Systems, e.g., Windows 95/98 and Windows NT, from Microsoft, Solaris from Sun Microsystems, Macintosh from Apple Computers, and Linux. The different types of operating systems will be referred to herein as “platforms”.

Content is delivered across the Internet to various platforms in the form of web pages. The look and feel of these web pages is largely dependent on Hypertext Markup Language (HTML) code. This code, which is understood by web browsers such as Microsoft® Internet Explorer® and Netscape® Communicator®, dictates attributes, position, and the like of the text and graphics on a web page. A web browser is a program that provides a way to view and interact with information on the Internet. Essentially, web browsers use the Hypertext Transfer Protocol (HTTP) to make requests of Web servers connected to the Internet on behalf of a user.

HTML (Hypertext Markup Language) is a set of markup symbols that tell a web browser how to display words and images to a user. Each individual markup code is referred to as an element or tag. Certain elements come in pairs that indicate the start and end of an effect. Those skilled in the art will appreciate that server-side and client-side scripts exist and can be used to tailor the operation of a web page.

An Active Server Page (ASP) is an HTML page that includes one or more scripts (small embedded programs) that are processed before the page is sent to the user. An ASP is similar to a server-side include or a common gateway interface (CGI) application in that all involve programs that run on the server, usually tailoring a web page for the user. Typically, the script in the web page at the server uses input received as the result of the user's request for the page to access data from a database and then updates the content of the page before sending it to the requester. ASP files can be created by including a script written in VBScript or JScript in an HTML file or by using ActiveX Data Object program statements in an HTML file.

Another generally server-side format is ColdFusion. ColdFusion is a development system for creating web pages and web applications. Web pages developed under the ColdFusion system contain both HTML and a tag-based server scripting language, called ColdFusion Markup Language (CFML). When the ColdFusion pages are requested, the CFML tags are processed on the server before returning a dynamically generated HTML page.

### SUMMARY OF INVENTION

In general, in one aspect, the present invention involves a system for creating and dynamically managing websites comprising a set of tables; a database associated with the set of tables; and a software tool for generating a web interface based on the database using the set of tables.

In general, in one aspect, the present invention involves a method for creating and dynamically managing websites comprising creating a set of tables associated with a database; and generating a web interface based on the database using the set of tables.

In general, in one aspect, the present invention involves an apparatus for creating and dynamically managing websites comprising means for creating a set of tables associated with a database; and means for generating a web interface based on the database using the set of tables.

Other aspects and advantages of the invention will be apparent from the following description and the appended claims.

### BRIEF DESCRIPTION OF DRAWINGS

FIG. 1 is a conventional computer.

FIG. 2 is a computer system network in accordance with an embodiment of the present invention.

FIG. 3 shows exemplary components of a system in accordance with an embodiment of the present invention.

FIG. 4 shows exemplary association between database tables and files in accordance with an embodiment of the present invention.

FIG. 5 shows an exemplary set of screens associated with the files in accordance with an embodiment of the present invention.

FIG. 6 shows an exemplary dialog box containing table properties.

FIG. 7 shows an exemplary dialog box containing website properties.

FIG. 8 shows a special menu items dialog box.

FIG. 9 shows a site wizard dialog box.

FIG. 10 is a flow chart describing a production website creation process in accordance with an embodiment of the present invention.

FIG. 11A shows an exemplary new site dialog box.

FIG. 11B shows an exemplary delete site dialog box.

FIG. 12 is a flow chart describing a trial website creation process in accordance with an embodiment of the present invention.

FIG. 13 shows an exemplary dialog box for the creation of a trial site.

FIG. 14 shows an exemplary dialog box for moving a trial site to production.

FIG. 15 is a flow chart describing an update process for production sites in accordance with an embodiment of the present invention.

FIG. 16 is a flow chart describing an update process for trial sites in accordance with an embodiment of the present invention.

FIG. 17 is a flow chart describing a database update process in accordance with an embodiment of the present invention.

FIG. 18 is a flow chart describing a database update process in accordance with an embodiment of the present invention.

FIG. 19 is a flow chart describing a database update process in accordance with an embodiment of the present invention.

FIG. 20 shows an exemplary mass update dialog box.

### DETAILED DESCRIPTION

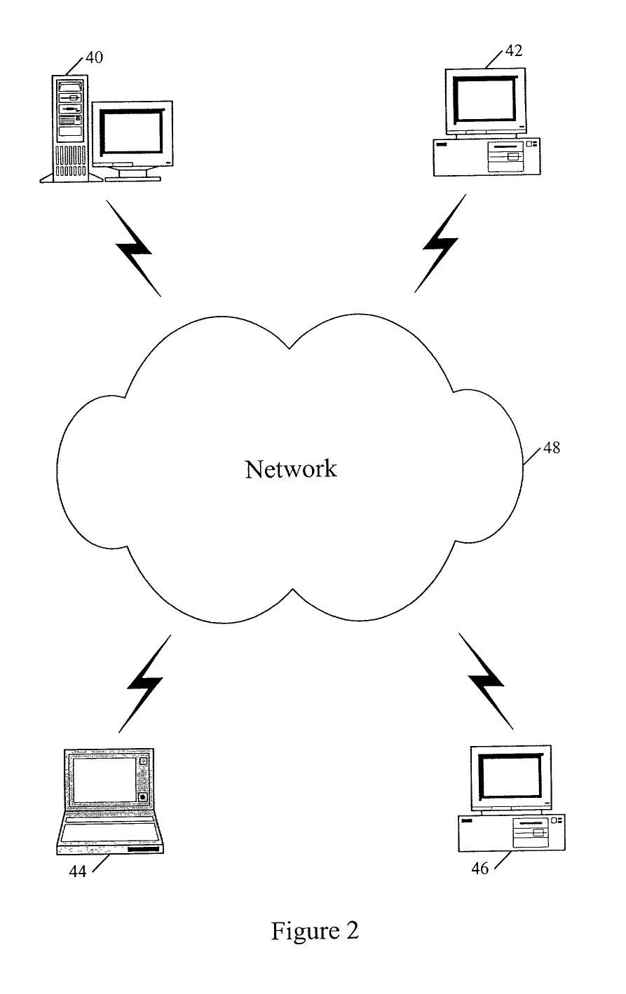

Referring to the drawings wherein like reference characters are used for like parts throughout the several views, FIG. 2 shows an embodiment of the present invention.

In general, in one or more embodiments, the invention can be embodied in electronic software residing in one or more computers (40), (42), (44), and (46) connected through a network (48). Those skilled in the art will appreciate the many possible configurations available that satisfy this requirement. The computers shown in FIG. 2 may be mainframe computers, network computers, web-browsing terminals, desktop computers, laptop computers, palmtop computers, etc., and may run under IBM-compatible operating systems, Macintosh operating systems, UNIX operating systems, etc. Further, the network (48) may be embodied in many different forms. The embodiments described below relate to websites published on the Internet. However, those skilled in the art will appreciate that the present invention is equally applicable to the production of pages for any type of network, e.g., a local intranet. Further, it will be understood by those skilled in the art that there are many methods of connecting to the Internet and publishing websites thereon.

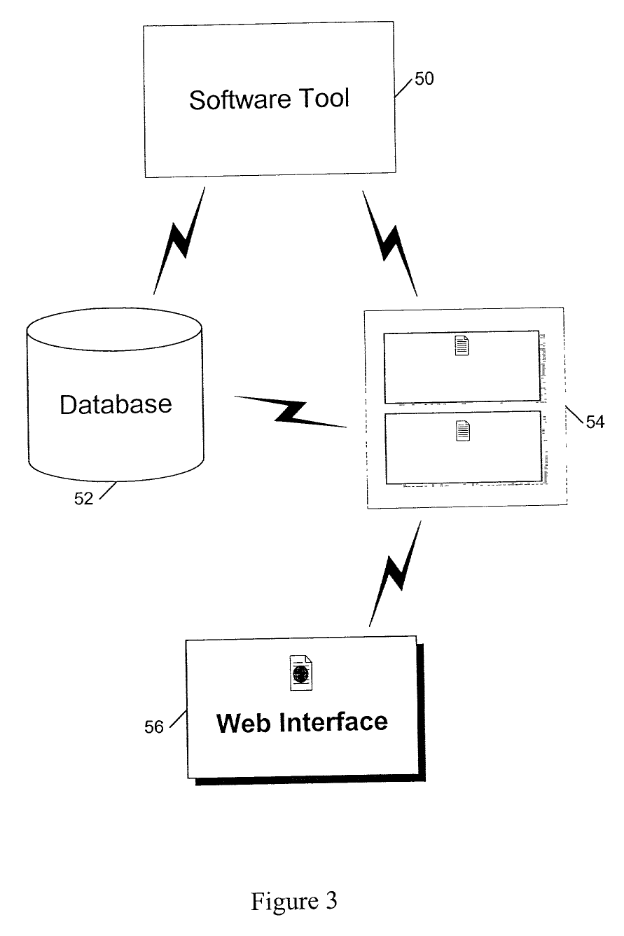

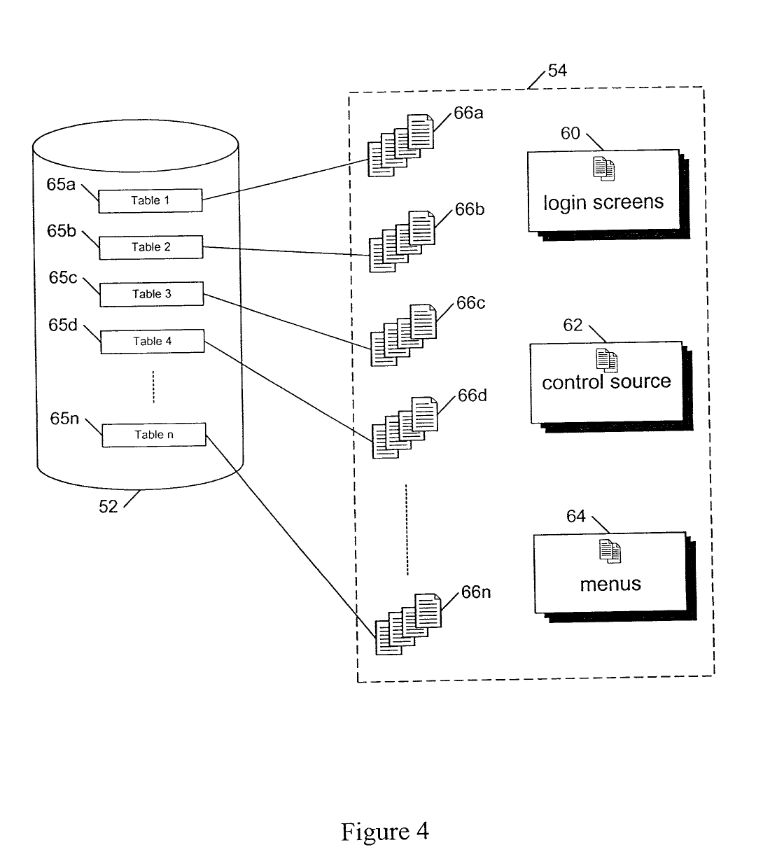

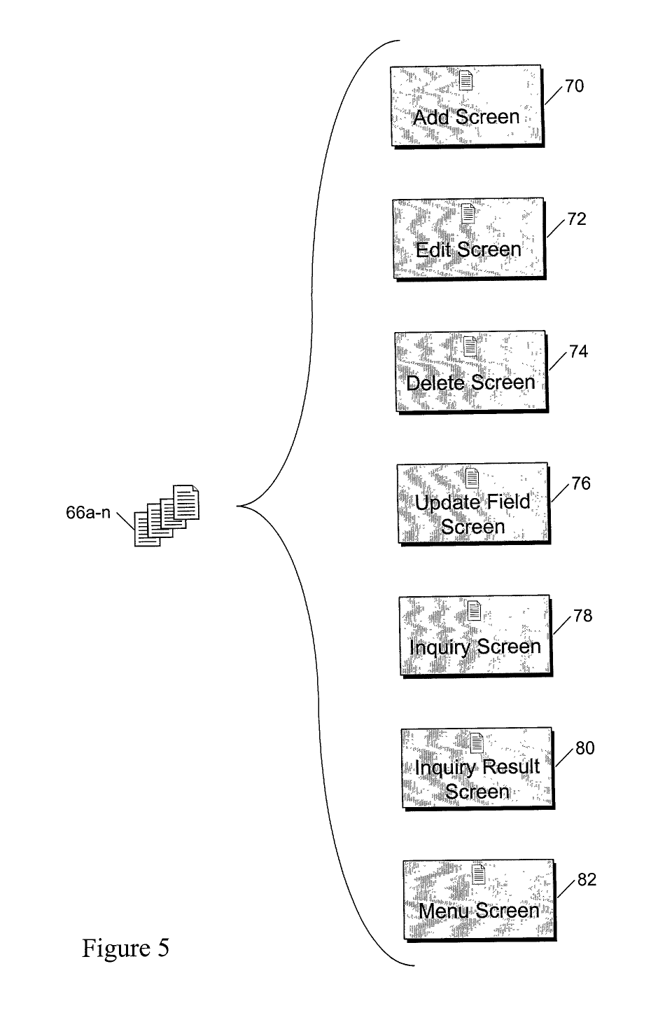

In one embodiment, the present invention may be a system that automatically creates and dynamically manages websites in real-time. Referring to FIGS. 3-5, a software tool (50) creates a website (54) to help maintain and control a database (52) through a web interface (56). The website (54) includes login screens (60), control source (62), menus (64), and multiple files (66a-n) for each table (65a-n) in the control database (52). The series of files (66a-n) may be, for example, an Add Screen (70), an Edit Screen (72), a Delete Screen (74), an Update File Screen (76), an Inquiry Screen (78), an Inquiry Result Screen (80), and a Menu Screen (82). Because the software tool (50) uses database (52) to build the website (54), the included components are fully customizable.

The software tool (50) has information about each table (65a-n) in the database (52). Each table (65a-n) can be designated as having a parent. Also, whether the parent or grandparent of a given table (65a-n) controls access to the table can be set. For example, an invoice may be the parent and each line of detail on the invoice may be a child. Further, tables have the attribute of being “used elsewhere.” This attribute allows protection against orphaning entries in related tables. The table can be “used elsewhere” which creates the files for the table but does not create an entry in the menu for the table or any special update code during an add, edit, or delete.

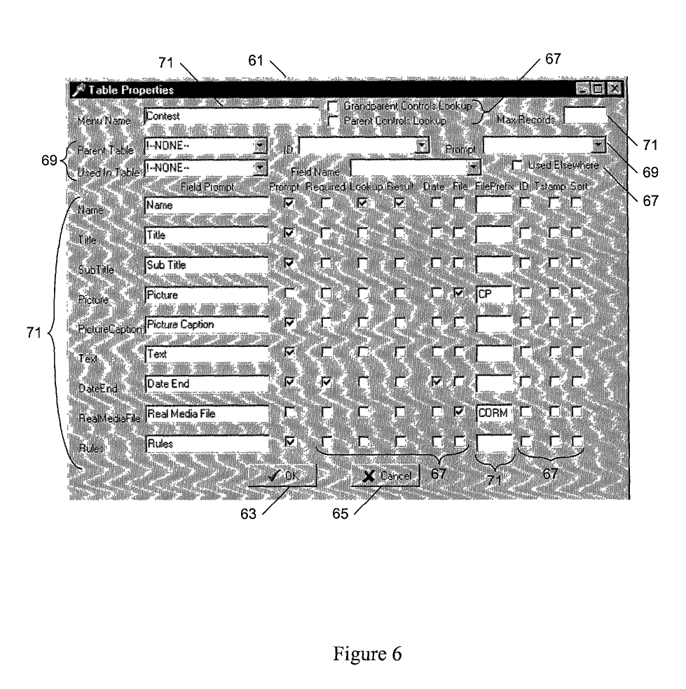

Referring to FIG. 6, an exemplary dialog box containing table properties is shown. As can be seen, the dialog box (61) is configured with a series of text and check boxes. These boxes provide the software tool (50) information about each field in each table (65a-n). The database provides certain information about each field, but for reasonable data entry far more attributes are needed. Thus, the software tool (50) tracks the table information in order to prompt for a field and determine characteristics of the field. The dialog box (61) also includes standard Ok (63) and Cancel (65) buttons, which operate in the conventional manner.

The field characteristics included on the table properties dialog box (61) are used to specify various system attributes. Check boxes (67) control whether to prompt users with the contained prompts on the lookup screen, whether the field is required; whether the field appears on the lookup page, whether the field appears on the result page; whether the field is a date field, a file upload field; a password field; a timestamp, whether the field is used in a sort on the result page; and whether the grandparent or parent controls lookup. Pull-down menus (69) dictate the parent table. The text boxes (71) contain the menu name, default values for field prompts, unique filename prefixes, and the maximum number of records for the table.

Other characteristics that may be included are whether a field is a unique field, an email field, etc.; whether to sort in descending order on result page; whether the field generates unique filenames or retains file names on upload; whether to permit executable file uploads; whether the field contains a DNS third level field name; whether the field is part of a many to many relationship; whether to retain old field value on edits; source table and table field and prompt field, sort order; image library entry code; standard image width and height size; name of memo overflow field, and special query constraints.

Further, the software tool (50) tracks created websites' properties.

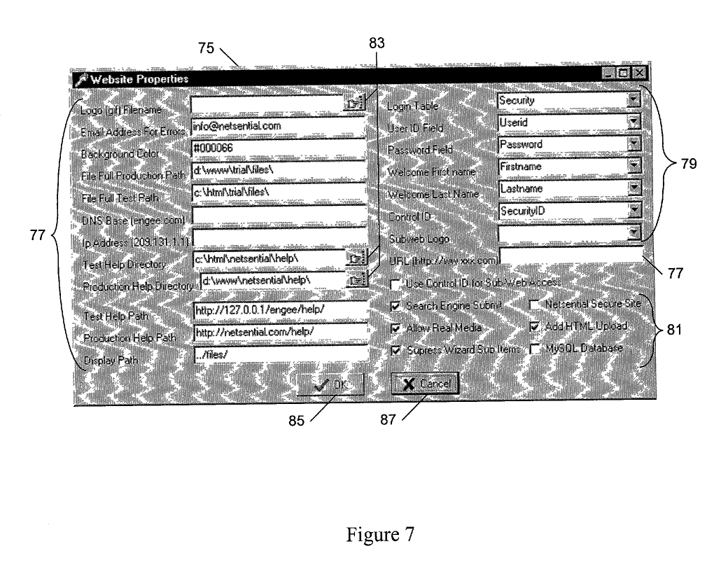

Referring to FIG. 7, an exemplary dialog box (75) for website properties is shown. As can be seen, text boxes (77) contain values for the website URL (uniform resource locator), the logo filename, email address for errors, and background color. Further, text boxes (77) contain values dictating the file full production and test paths, DNS base address, IP address, test and production help directories, and display path. Text boxes may include a browse button (83) that allows a user to browse through the directories on their computer and mapped network drives to select path names and files.

Pull-down menus (79) allow a user to select the login table, user ID and password fields, welcome first and last names, control ID, and subweb logo. The dialog box (75) also contains check boxes (81) for controlling whether the control ID is used for subweb access; whether to submit the website URL and description to Internet search engines; whether to allow real media; whether to suppress wizard sub items; whether the website is a secure site; whether to allow HTML uploads; and whether to use a MySQL database. Finally, the dialog box (75) also includes standard Ok (85) and Cancel (87) buttons, which operate in the conventional manner.

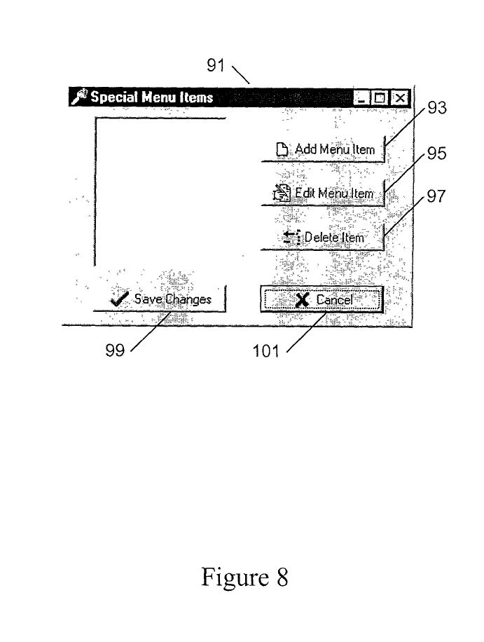

The software tool (50) allows the selection of any table (65a-n) in a database (52) to hold login/password pairs. The system creates login screen (60) and validates login/password pairs. At the beginning of each template, the system validates that the interaction is done in a secure session. This prevents unauthorized users from jumping into the middle of a secure site and making changes. Also, the security role is checked for the current login. The role allows add/edit/delete access on both entire tables and data sensitive areas. The levels of each role entry is to allow or disallow a user access to login, access to tables, access to field names, and access to field data. Referring to FIG. 8, the software tool (50) allows users to modify menu items, each pointing to a file, through a special menu items dialog box (91). The dialog box (91) contains buttons for adding a menu item (93), editing a menu item (95), and deleting a menu item (97). Also, the dialog box (91) includes standard save changes (99) and cancel (101) buttons.

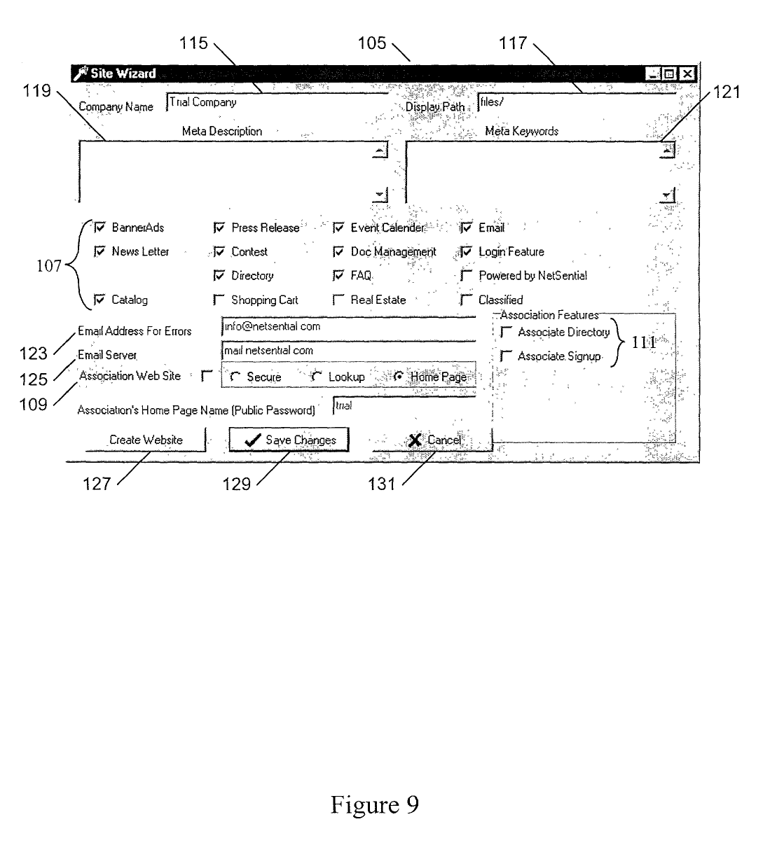

Referring to FIG. 9, production sites are created using a visual “check-box” interface. Through the site wizard dialog box (105), the software tool (50) manages the exact features and functions via the check-box options (107). Though the selection of these options, a user is allowed to choose which modules are created on the site, such as Banner Ads, Newsletters, Catalog, Shopping Cart, Press Release, Contest, Directory, Event Calendar, Document Management, Frequently Asked Questions (FAQ), Real Estate, Classified, etc. Also, the system determines whether the site is a “plain” site or one for associates (109). Association websites include additional features (111) such as an association directory and associate signup, and a text box (113) is included for entry of the association home page name. The dialog box (105) includes text boxes for entry of the company name (115), display path (117), meta tags (description (119) and keywords (121)), email address for errors (123) and email server (125). Finally, the site wizard dialog box (105) includes create website (127), save changes (129), and cancel (131) buttons.

Software tool (50) creates and manages trial and production sites. Both trial and production sites consist of several directories, a public site, and a secure private administrative site. As discussed above, the public and private sites are fully customizable. The software tool (50) creates the website by examining the options configured and writing the application code.

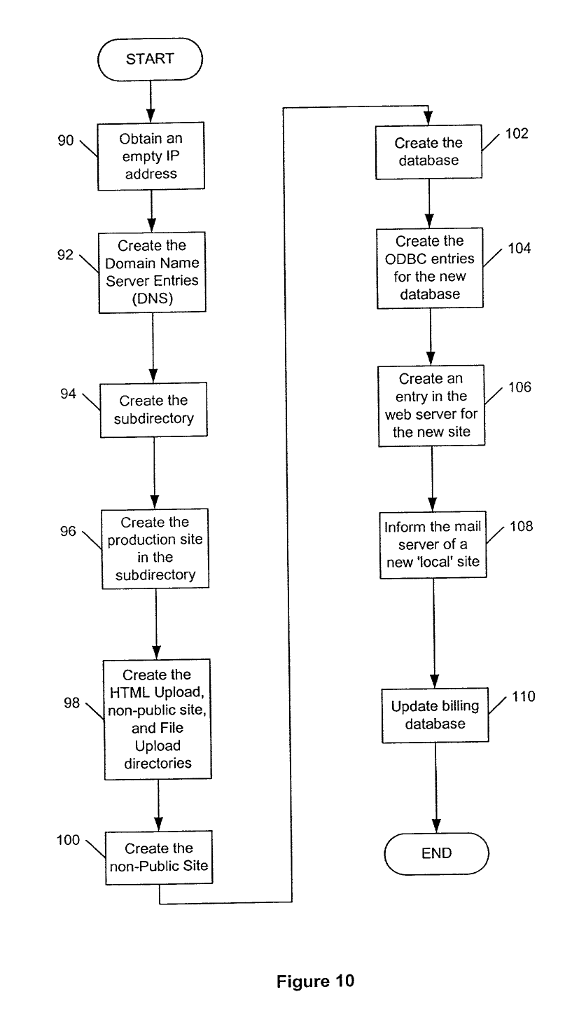

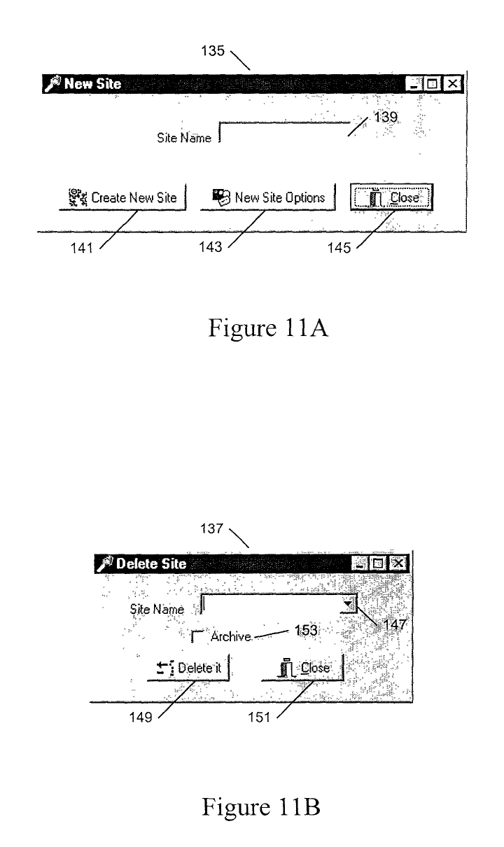

Referring to FIG. 10, creating a production site occurs in the following manner. First, an empty IP address is obtained (step 90) and the Domain Name Server (DNS) Entries are created (step 92). Next, a site directory is created (step 94) for the obtained IP address. The production site is created in the directory using the process described above (step 96). Also, the HTML Upload, non-public site, and File Upload directories are created. Then, the software tool (50) creates the non-Public Site (step 100), the database (step 102), the ODBC entries for the new database (step 104), and an entry in the web server for the new site (step 106). Finally, the mail server is informed of the new ‘local’ site (step 108) and the client billing database is updated (step 110). The deletion of a production site follows the same steps in reverse order, with the reverse effects. The production site is archived by coping the database and uploaded files directory to an archive directory.

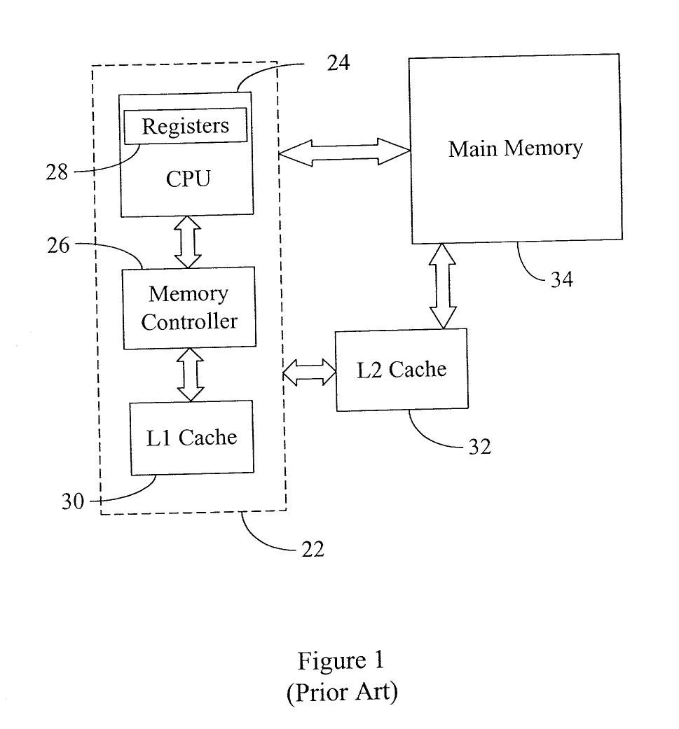

Referring to FIGS. 1A and 1B, the software tool (50) displays dialog boxes (135) and (137) respectively to allow users to create or delete production websites. The new site dialog box (135) includes a text box (139) for entry of the new website name, create new site button (141), new site options button (143) for accessing website options, and a standard close button (145). The delete site dialog box (137) includes a pull-down menu (147), a delete button (149), and a standard close button (151). Also, the delete site dialog box (137) includes a check box (153) allowing a user to select whether to delete the archive of the website being deleted.

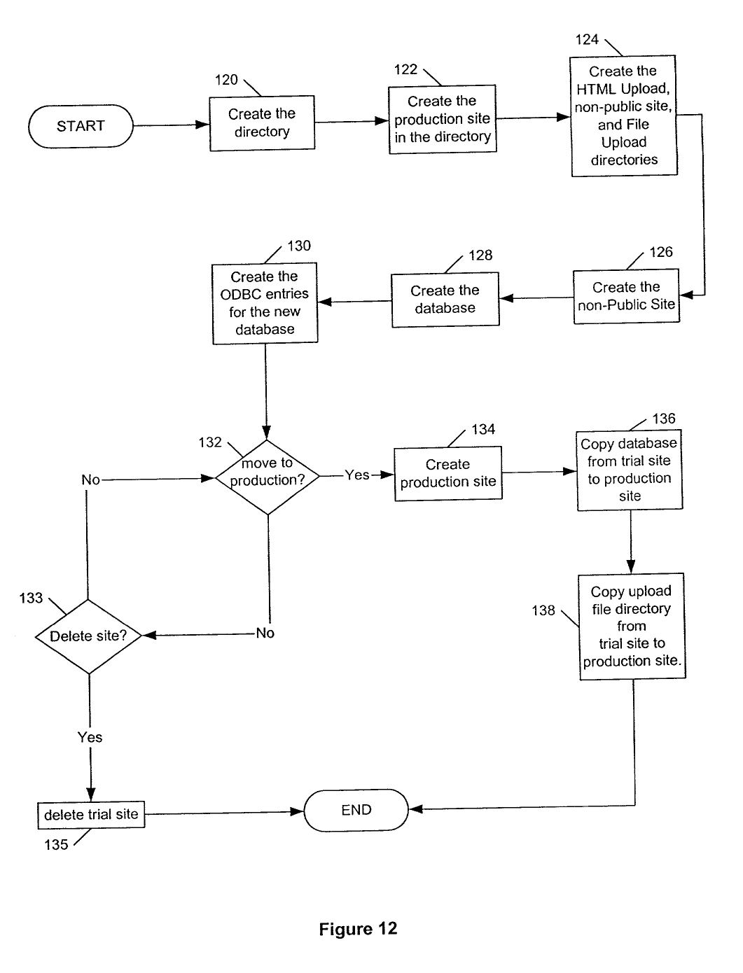

The addition of a Trial Site is essentially the same as the creation of a production site, however, trial sites are created under an existing URL, e.g., www.netsential.com. Referring to FIG. 12, a trial site is added by the following process. First, a subdirectory is created under an existing site directory (step 120). Then, the production site is created in the subdirectory (step 122). Also, the HTML Upload, non-public site, and File Upload directories are created (step 124). Next, the software tool (50) creates the non-Public Site (step 126), the database (step 128), and the ODBC entries for the new database (step 130). The software tool (50) then checks whether the trial site should be moved into production (step 132).

If so, a production site is created, e.g., as described above, preserving the database and upload file directory from the trial site. Thus, the production site is created (step 134), the database from trial site is copied to the production site (step 136), and the upload directory from the trial site is copied to the production site (step 138). Moving a trial site into production ends the process.

If, on the other hand, the site is not moved into production (step 132), a check is performed to determine whether the site should be deleted (step 133). Trial site may be restricted, for instance, to certain lengths of time. Thus, trial sites that are determined to exceed a restriction should be deleted. If the software tool (50) determines that the site should be deleted (step 133), the trial site is deleted (step 135) and the process ends. Otherwise, the software tool (50) continues to monitor whether the trial site should be moved into production (step 132) or deleted (step 133).

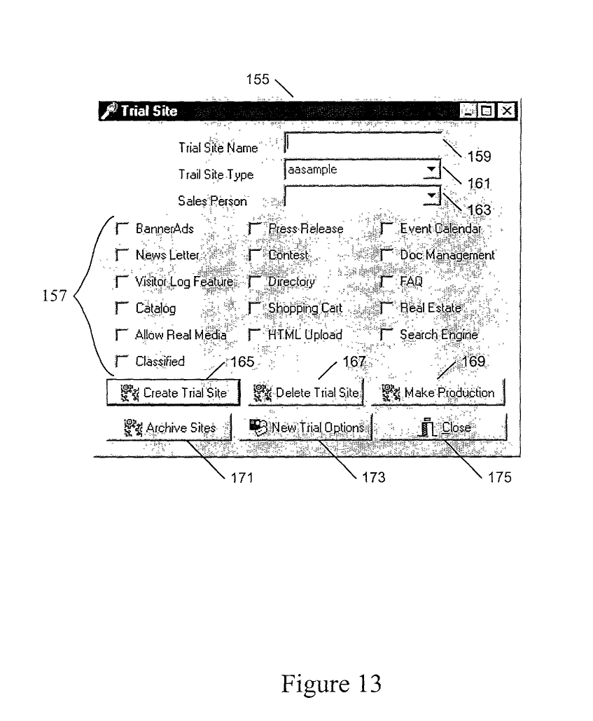

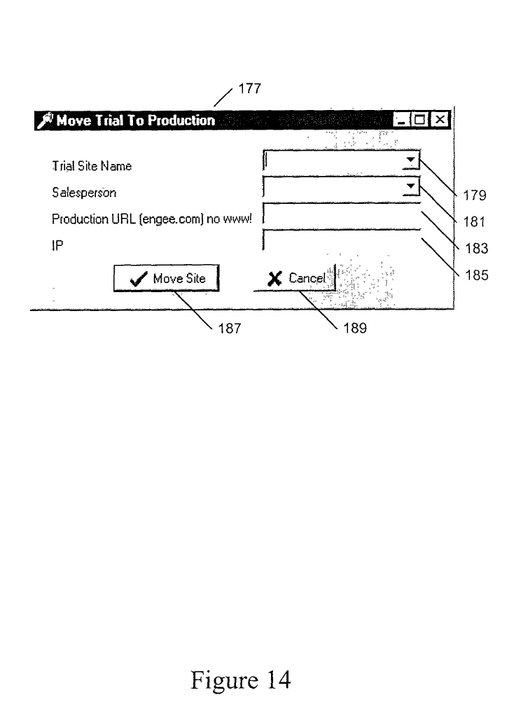

Referring to FIGS. 13 and 14, the dialog boxes for the creation of a trial site and moving a trial site to production are shown. As can be seen, the trial site dialog box (155) includes check boxes (157) for selecting options similar to those of site wizard (105). Also, the trial site dialog box (155) contains a text box (159) for entry of the trial site name, a pull-down menu (161) for trial site type, and a pull-down menu (163) for tracking the sales person involved with the trial site. Control buttons are included for creation of the trial site (165), deletion of the trial site (167), moving the trial site to production (169), archiving sites (171), new trial site options (173), and a standard close (175). Upon user selection of the make production site button (169), the Move Trial to Production dialog box (177) appears. The Move Trial to Production dialog box (177) includes pull-down menus for tracking the site name (179) and salesperson involved (181) and text boxes for entry of the production URL (183) and IP address (185). Further, the dialog box (177) has a move site button (187) and standard cancel button (189).

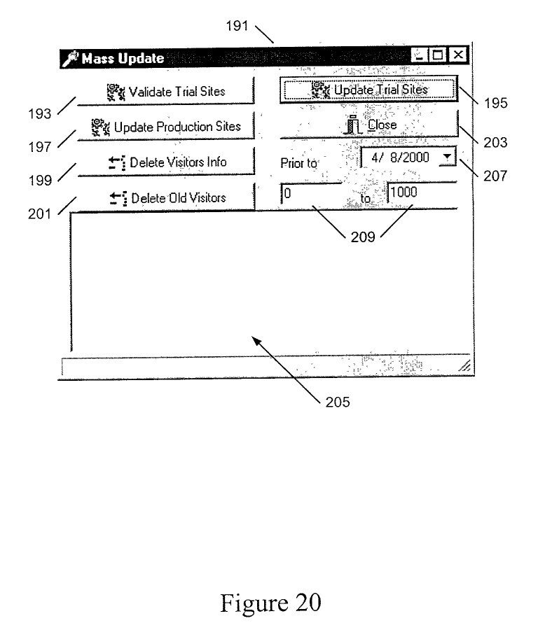

When changes are made to the web software and/or database design, it is important to provide the latest version to every website built or maintained by the system. In order to efficiently deliver these updates, client web sites are updated by the system “en mass.” Mass update of production sites occurs using the following mass update procedure. A mass update dialog box (191), which controls the mass update and visitor deletion processes described below, is shown in FIG. 20.

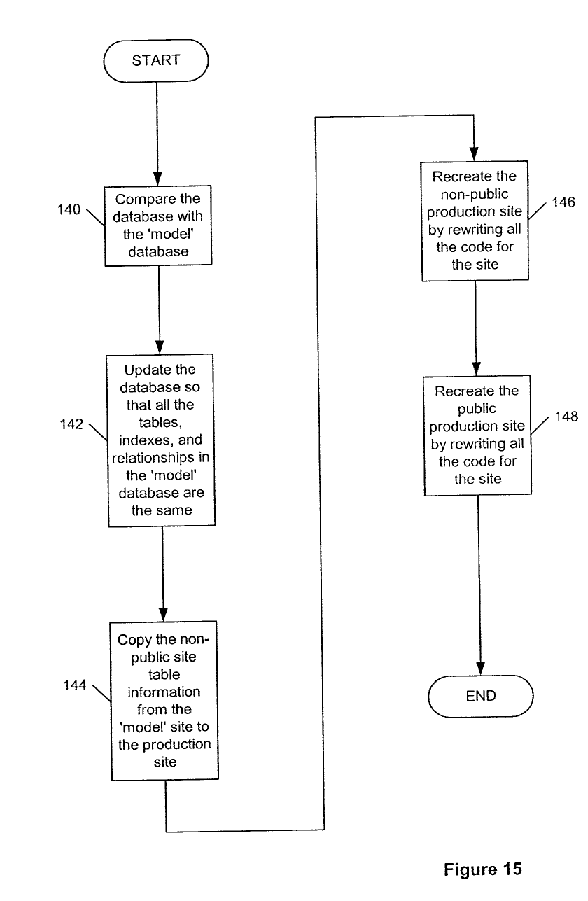

Referring to FIG. 15, for each production site that receives periodic updates, the production site database is compared with the model database (step 140). The model database is the main system database containing the latest updates. The production site database is then updated so that all the tables, indexes, and relationships in the model database are the same (step 142). Nonpublic site table information is copied from the model site to the production site (step 144). Next, the non-public site is re-created by rewriting all the code for the site (step 146). Finally, the public site is re-created by rewriting all the code for the site (step 148).

For trial sites the update is essentially the same overall procedure.

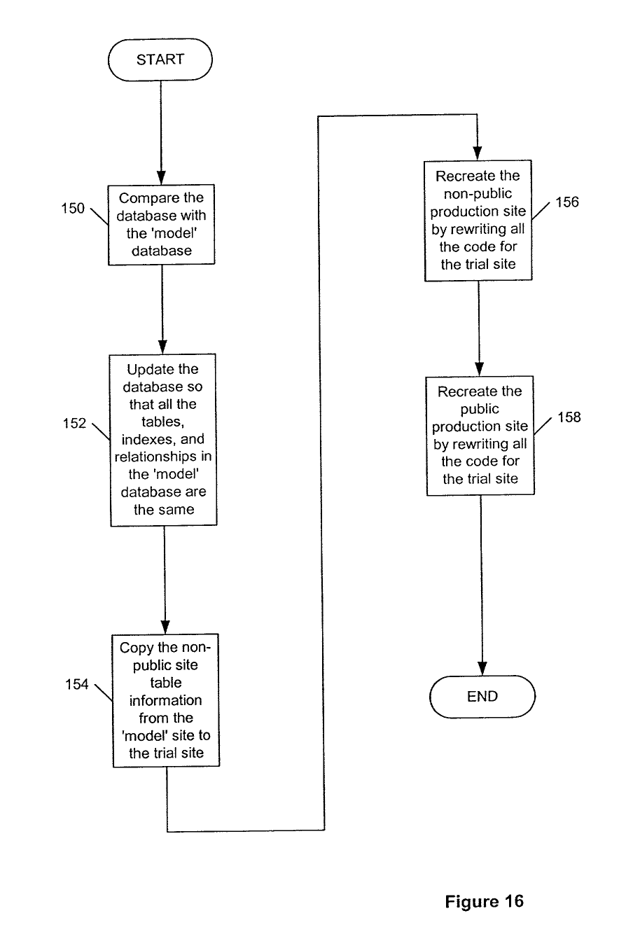

Referring to FIG. 16, for each production site that receives periodic updates, the trial site database is compared with the model database (step 150). The trial site database is then updated so that all the tables, indexes, and relationships in the model database are the same (step 152). Non-public site table information is copied from the model site to the trial site (step 154). Next, the non-public site is re-created by rewriting all the code for the site (step 156). Finally, the public site is re-created by rewriting all the code for the site (step 158). Those skilled in the art will appreciate that the re-creation of the trial site follows the process discussed above for adding trial sites, whereas the re-creation of production sites follows the process discussed above for adding production sites.

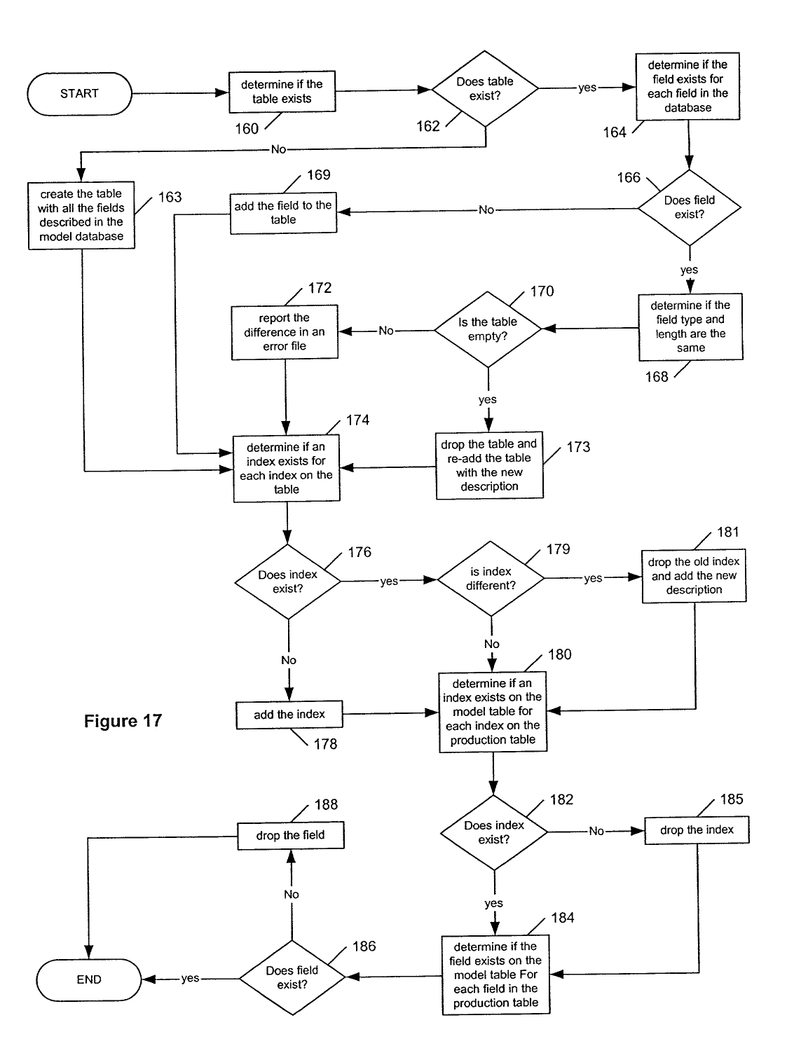

Referring to FIG. 17, the database update of the mass updates (steps 142 and 152) performs the following algorithm. For each table in the model database, the system checks to see if the table exists (step 160). If the table does not exist (step 162), the system creates the table with all the fields described in the model database (step 163). If the table does exist (step 162), then the system determines whether a field exists for each field in the database (step 164). If the field does not exist (step 166), the field is added to the table (step 169). If the field does exist (step 166), the field type and length are compared to determine that they are the same (step 168). If the field length or type is different (step 168) then determine whether the table is empty (step 170). If the table is empty (step 170), drop the table and re-add the table with the new description (step 173). If the table has entries (170) report the difference in an error file (step 172).

For each index on the table check to see if the index exists (step 174). If the index does not exist (step 176) add the index (step 178). If the index does exist (step 176), determine if different (step 179). If the existing index is different (step 178), drop the old index and add the new description (step 181).

For each index on the production table check to see if the index exists on the model table (step 180). If the index does not exist on the model table (step 182) then drop the index (185). For each field in the production table check to see if the field exists on the model table (184). If the field does not exist (186) on the model table then drop the field (188).

The model database also has “standard information” as described above. This information complements the data structure defined in the design of the database. For each table in the model database the mass update copies the standard information from the model database description file to the production database description file.

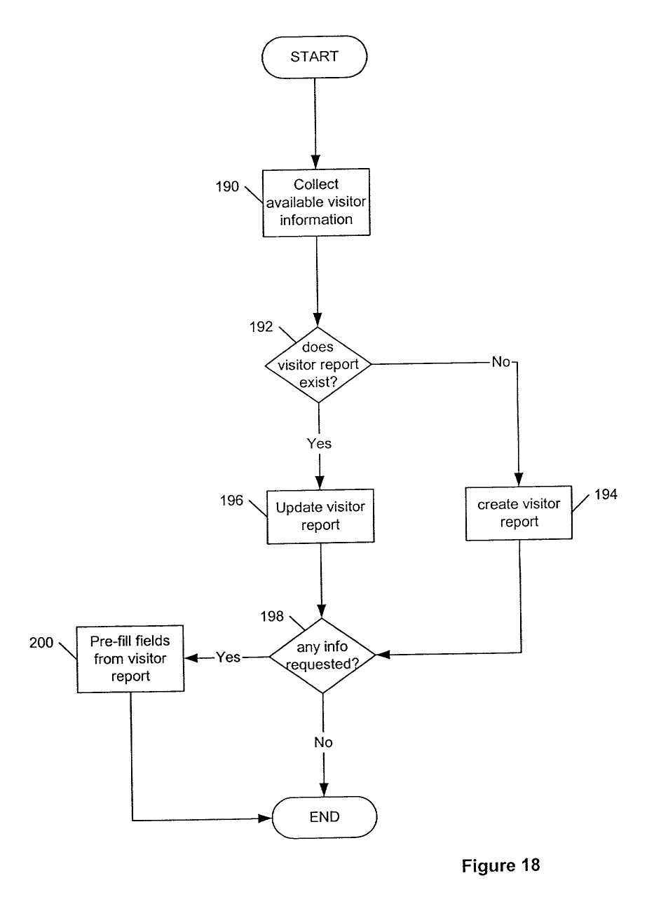

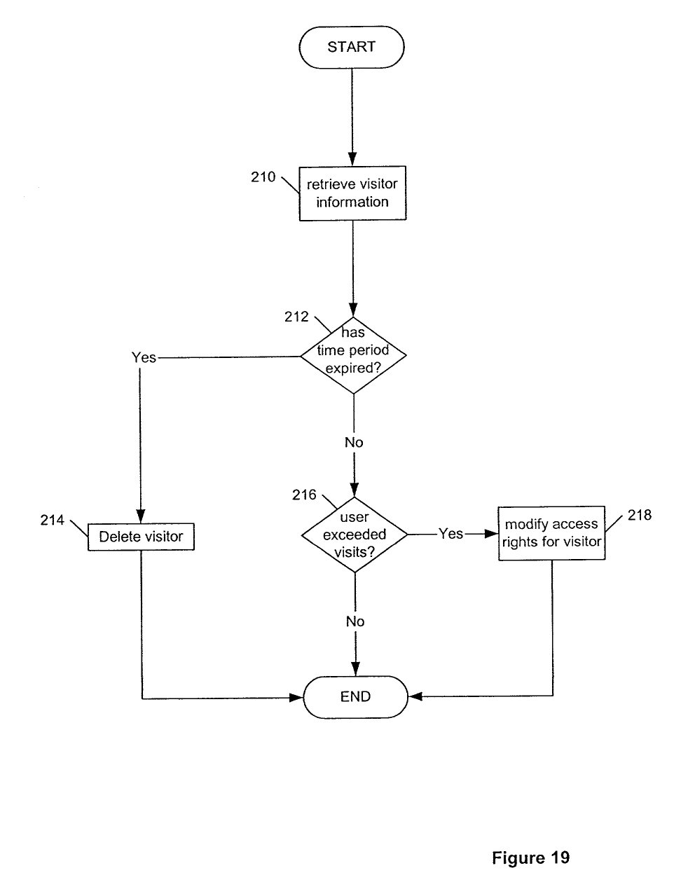

Referring to FIGS. 18-19, the software tool (50) tracks visitors through the use of “cookies.” The use of cookies is well known to those skilled in the art. For each visitor, the system tracks name, address, email, and any additional information available. Also, each visit a particular visitor makes is tracked. When a visitor arrives, this information is collected (step 190) and, if a visitor report does not already exist (step 192), a visitor report is created (step 194). If a visitor report does exist (step 192) the information collected is used to update the existing visitor report (step 196). The information contained in a visitor report is used to pre-fill forms (step 200) whenever the visitor reaches a page requesting a name, address, or the like (step 198).

For efficiency, visitor reports are deleted after a specified start period, e.g., at the start every month. When the specified start period occurs, visitor reports are retrieved (step 210). The visitor report for any visitors who have not returned in a specified interval, e.g., 6 months, are then deleted. Thus, the system determines from the retrieved visitor reports which visitors have not returned for the specified interval (step 212) and deletes those visitors (step 214). Further, the system may restrict access to resources for users after a specified number of visits. Accordingly, for all visitor reports not expired in time (step 212), the system determines whether the number of visits has been exceeded (step 216). If so, the visitors access rights are modified (step 218). Otherwise, the process ends.

Referring to FIG. 20, the mass update dialog box (191) includes buttons for the validation of trial sites (193), update of trial sites (195), update of production sites (197), deletion of visitor information (199), deletion of old visitors (201), and closing the dialog box (203). The mass update dialog box (191) also includes a window (205) for displaying results matching a prior-to-date pull-down box (207) and visitor number range (209).

Advantages of the present invention may include one or more of the following. The system disclosed allows efficient creation and maintenance of websites. The processes and operations of the system are optimized to ensure error-free code is quickly generated.

While the present invention has been described with respect to a limited number of preferred embodiments, those skilled in the art will appreciate numerous modifications and variations therefrom. The appended claims are intended to cover all such modifications and variations which occur to one of ordinary skill in the art.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A system for creating and dynamically managing websites comprising:
a set of tables;
a database associated with the set of tables; and
a software tool for generating a web interface based on the database using the set of tables.

2. The system of claim 1, wherein the software tool is adapted to manage selected information in each of the tables of the set of tables.

3. The system of claim 1, wherein the software tool is adapted to manage selected information about properties of the web interface.

4. The system of claim 3, wherein the properties comprise at least one selected from the group of values for a website URL, a logo file name, an email address for errors, a background color, a file path, a DNS base address, an IP address, a help directory address, and a display path.

5. The system of claim 1, wherein the software tool is adapted to enable modification of menu items for a selected file of the web interface corresponding to one of the tables of the set of tables.

6. The system of claim 1, wherein the software tool is adapted to enable selection of features and functions for the web interface and is adapted to create the web interface based on the selected features and functions.

7. The system of claim 1, wherein the software tool is adapted to create a web interface by examining user-selectable options stored in the set of tables and writing a corresponding application code based on the selected options.

8. The system of claim 1, wherein the software tool is adapted to create a plurality of web interfaces and is adapted to enable a mass update to each of the web interfaces in the plurality of web interfaces based on changes made to at least one selected from the group of the software tool and the database.

9. The system of claim 1, wherein the software tool is adapted to track visitors to a selected website and to modify a visitor's rights based on a selected number of visits made to the website.

10. A method for creating and dynamically managing websites comprising:
creating a set of tables associated with a database; and
generating a web interface based on the database using the set of tables.

11. The method of claim 10, wherein creating a set of tables comprises:
selecting table properties including field characteristics and field values for each of the tables of the set of tables;
selecting web interface properties;
selecting web interface menu items; and
selecting web interface features and functions.

12. The method of claim 10, wherein generating a web interface comprises:
creating a site directory;
creating a website in the site directory using a software tool that automatically generates code for the website based the set of tables; and
creating entries on a web server representing the created website.

13. The method of claim 12, further comprising:
monitoring a status of the website; and
modifying access to the website based on the status.

14. The method of claim 12, wherein generating a web interface further comprises at least one selected from the group of:
selectively deleting the website after a trial period has expired; and
selectively converting the website into a production website that is not deleted after the trial period has expired.

15. The method of claim 12, further comprising:
updating the website when changes are made to at least one selected from the group of the software tool and the database.

16. The method of claim 15, wherein updating the website comprises:
comparing the database with a model database;
updating the database based on the comparison;
recreating the website in the site directory based on the updated database.

17. The method of claim 12, further comprising tracking visitors to the website, wherein the tracking visitors comprises:
collecting visitor information;
creating a visitor report for each new visitor based on the collected visitor information;
updating the visitor report for each return visitor based on the collected visitor information.

18. The method of claim 17, wherein the tracking visitors further comprises:
retrieving visitor information;
deleting the visitor information after a selected time period expires; and
modifying access rights for visitors based on the visitor information.

19. An apparatus for creating and dynamically managing websites comprising:
means for populating a database with information from a set of tables; and
means for generating a web interface based on the database using the set of tables.

20. An apparatus of claim 19, further comprising:
means for re-generating the web interface when information in the database is modified.
